(19) United States
(12) Patent Application Publication
(10) Pub. No.: US 2024/0055984 A1
(43) Pub. Date: Feb. 15, 2024

(54) BIDIRECTIONAL UNIVERSAL SERIAL BUS POWER DELIVERY PORTS

(71) Applicant: MILWAUKEE ELECTRIC TOOL CORPORATION, Brookfield, WI (US)

(72) Inventors: Nathan J. Gustafson, Milwaukee, WI (US); Nicholas S. Brucks, Brookfield, WI (US)

(21) Appl. No.: 18/366,911

(22) Filed: Aug. 8, 2023

Related U.S. Application Data
(60) Provisional application No. 63/397,109, filed on Aug. 11, 2022.

(51) Int. Cl. H02M 3/04; H02J 7/00

(52) U.S. Cl. CPC H02M 3/04; H02J 7/0063

(57) ABSTRACT

A power tool including a dual role port, a bidirectional converter device, and an electronic controller. The dual role port is configured to receive power from an external device or provide power to the external device. The bidirectional converter device is connected to the dual role port, and is configured to transfer power from the dual role port to a power source of the power tool. The electronic controller is configured to determine that the external device is connected to the dual role port. The electronic controller is also configured to determine a role of the dual role port. The electronic controller is further configured to control operation of the dual role port.

### RELATED APPLICATIONS

This application claims the benefit of U.S. Provisional Patent Application No. 63/397,109, filed Aug. 11, 2022, the entire content of which is hereby incorporated by reference.

### FIELD

Embodiments described herein relate to power tools and battery packs.

### SUMMARY

Power tools described herein include a dual role port, a bidirectional converter device, and an electronic controller. The dual role port is configured to receive power from an external device or provide power to the external device. The bidirectional converter device is connected to the dual role port and is configured to transfer power from the dual role port to a power source of the power tool. The electronic controller is configured to determine that the external device is connected to the dual role port. The electronic controller is also configured to determine a role of the dual role port. The electronic controller is further configured to control operation of the dual role port.

Battery packs described herein include a dual role port, a bidirectional converter device, and an electronic controller. The dual role port is configured to receive power from an external device or provide power to the external device. The bidirectional converter device is connected to the dual role port and is configured to transfer power from the dual role port to a power tool or battery cells of the battery pack. The electronic controller is configured to determine that the external device is connected to the dual role port. The electronic controller is also configured to determine a role of the dual role port. The electronic controller is further configured to control operation of the dual role port.

Systems described herein include an external device, a power source, a dual role port, a bidirectional DC-DC converter device, and an electronic controller. The dual role port electrically and communicatively connectable to the external device. The dual role port configured to receive power from the external device or provide power to the external device. The bidirectional DC-DC converter device electrically connectable to the power source and the dual role port. The bidirectional DC-DC converter device is configured to transfer power to at least one of the power source or the dual role port. The electronic controller connected to the dual role port, the power source, and the bidirectional DC-DC converter device. The electronic controller is configured to determine that the external device is connected to the dual role port. The electronic controller is also configured to determine a role of the dual role port. The electronic controller is further configured to control operation of the dual role port.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1A illustrates a power tool, according to some embodiments.

FIG. 1B illustrates a battery pack according to embodiments described herein.

FIG. 2A illustrates a control system for the power tool of FIG. 1A, according to some embodiments.

FIG. 2B illustrates a control system for the battery pack of FIG. 1B, according to some embodiments.

FIG. 3A illustrates a wireless communication controller for the power tool of FIG. 1A, according to some embodiments.

FIG. 3B illustrates a wireless communication controller for the battery pack of FIG. 1B, according to some embodiments.

FIG. 3C illustrates a user interface for the power tool of FIG. 1A, the battery pack of FIG. 1B, and/or an external device, according to some embodiments.

FIG. 4 illustrates a communication system for the power tool of FIG. 1A, the battery pack of FIG. 1B, and the external device, according to some embodiments.

FIG. 5A illustrates a general schematic of a bidirectional ports system, according to some embodiments.

FIG. 5B provides an illustration of a bidirectional port system 700 integrated within the power tool of FIG. 1A, according to some embodiments.

FIG. 5C provides an illustration of a bidirectional port system 750 integrated within the battery pack of FIG. 1B, according to some embodiments.

FIG. 6 illustrates a method executed by the controller of the power tool of FIG. 1A, according to some embodiments.

FIG. 7 illustrates a method executed by the controller of the battery pack of FIG. 1B, according to some embodiments.

### DETAILED DESCRIPTION

Embodiments described herein relate to a power tool that is configured to implement bidirectional control of a USB-C Power Delivery (PD) port to provide power to the power tool from an external power source, or from the power tool to the external power source. In some embodiments, a battery pack that is coupleable to the power tool is configured to implement bidirectional control of a USB-C Power Delivery (PD) port to provide power to the power tool from an external source, or from the battery pack to the external power source. The USB-C Power Delivery (PD) port may be implemented in the power tool or the battery pack to replace a charging device and provide an additional discharge path for the external power source.

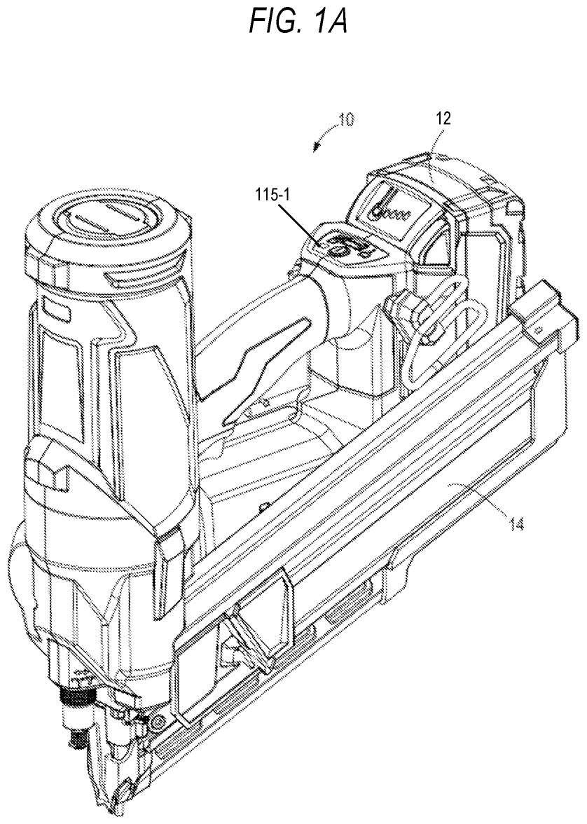

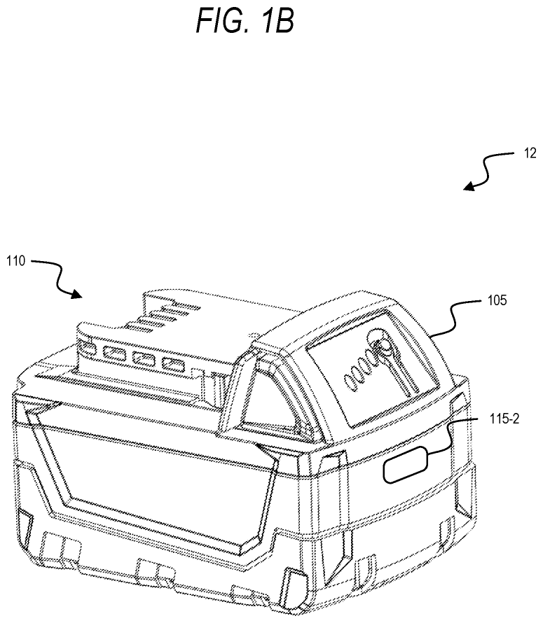

FIG. 1A illustrates a power tool 10, such as a fastener driver or nailer (e.g., a gas spring-powered nailer), that is operable to drive fasteners (e.g., single-headed nails, double-headed or duplex nails, tacks, staples, etc.) held within a magazine 14 into a workpiece. The power tool 10 is powered by a removable and rechargeable battery pack 12. In some embodiments, the power tool 10 includes a USB port 115-1 configurable to deliver power of the rechargeable battery pack 12 to a device connected to the USB port 115-1 as an additional discharge path for the rechargeable battery pack 12 connected to the power tool 10.

Additionally, the USB port 115-1 is configurable to deliver power of the device connected to the USB port 115-1 to the rechargeable battery pack 12 and/or the power tool 10.

In other embodiments, the power tool 10 is a different type of power tool. For example, the power tool 10 may be an impact wrench, a ratchet, a saw, a hammer drill, an impact driver, a rotary hammer, a grinder, a blower, or a trimmer. In this example, the power tool may also be associated with a class of power tools, such as, vacuums, string trimmers, blowers, drills, saws, lights, power edgers, general trimmers, chainsaws, table saws, miter saws, reciprocating saws, powered sprayers, air compressors, etc. In some embodiments, the power tool 10 is a power supply device or power source that receives one or more battery packs 12. In some embodiments, the power tool 10 may be assigned to a class based on a required operating voltage of the power tool 10.

FIG. 1B illustrates the rechargeable battery pack 12. The rechargeable battery pack 12 includes a housing 105, a device interface portion 110 for connecting the rechargeable battery pack 12 to a device (e.g., the power tool 10), and a USB port 115-2. The USB port 115-2 is configurable to deliver power of the rechargeable battery pack 12 to a device connected to the USB port 115-2. Additionally, the USB port 115-2 is configurable to deliver power of the device connected to the USB port 115-2 to the rechargeable battery pack 12 or the power tool 10. The rechargeable battery pack 12 may include a plurality of battery cells within the housing 105. In some embodiments, the rechargeable battery pack 12 includes a user interface portion for providing a state-of-charge indication for the rechargeable battery pack 12.

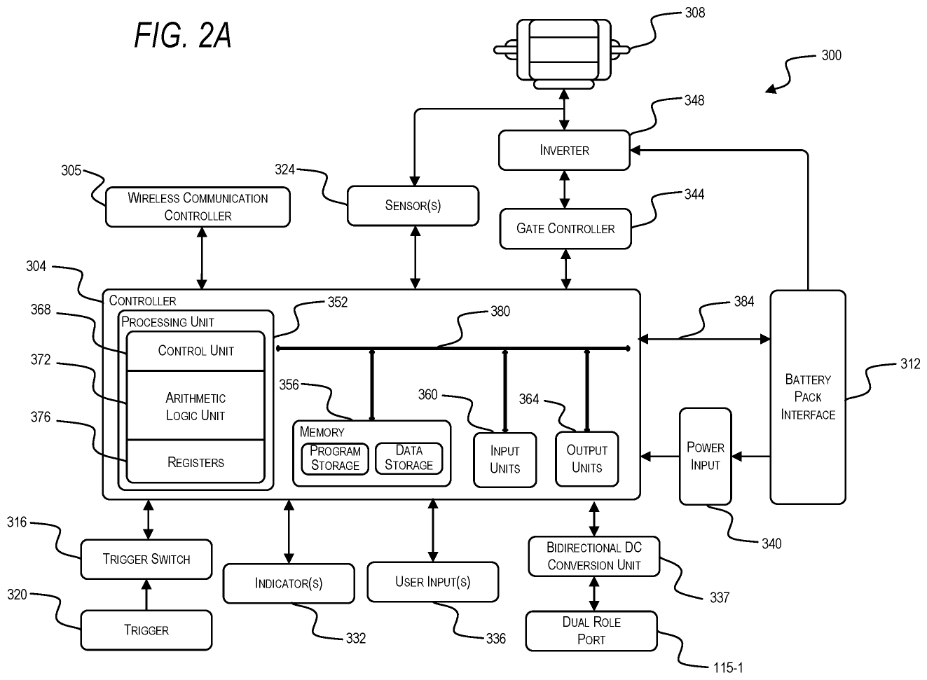

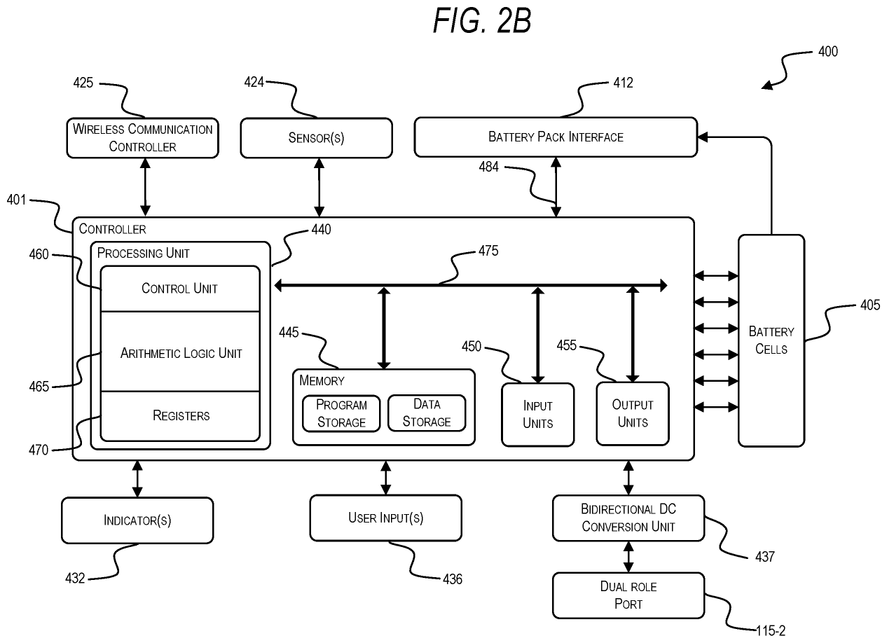

FIG. 2A illustrates a control system 300 for the power tool 10. The control system 300 includes a controller 304. The controller 304 is electrically and/or communicatively connected to a variety of modules or components of the power tool 10. For example, the illustrated controller 304 is electrically connected to a wireless communication controller 305, a motor 308, a battery pack interface 312, a trigger switch 316 (connected to a trigger 320), one or more sensors 324 (e.g., a current sensor, a position sensor, etc.), one or more indicators 332, one or more user input modules 336, the USB port 115-1 (connected to a bidirectional DC conversion unit 337, a power input module 340, and a gate controller 344 (connected to an inverter 348). The motor 308 includes a rotor, a stator, and a shaft that rotates about a longitudinal axis. The power input module 340 and the bidirectional DC conversion unit 337 will be described in more detail below.

The controller 304 includes combinations of hardware and software that are operable to, among other things, control the operation of the power tool 10, control and/or modify the operation of the USB port 115-1, monitor the operation of the power tool 10, activate the one or more indicators 332 (e.g., an LED), etc. The gate controller 344 is configured to control the inverter 348 to convert a DC power supply to phase signals for powering the phases of the motor 308. The current sensor 324 is configured to, for example, sense a current between one or more components of the power tool 10. The bidirectional DC conversion unit 337 is configured to transfer power between the USB port 115-1 and a power source.

The controller 304 includes a plurality of electrical and electronic components that provide power, operational control, and protection to the components and modules within the controller 304 and/or the power tool 10. For example, the controller 304 includes, among other things, a processing unit 352 (e.g., a microprocessor, a microcontroller, or another suitable programmable device), a memory 356, input units 360, and output units 364. The processing unit 352 includes, among other things, a control unit 368, an arithmetic logic unit (“ALU”) 372, and a plurality of registers 376, and is implemented using a known computer architecture (e.g., a modified Harvard architecture, a von Neumann architecture, etc.). The processing unit 352, the memory 356, the input units 360, and the output units 364, as well as the various modules or circuits connected to the controller 304 are connected by one or more control and/or data buses (e.g., common bus 380). The control and/or data buses are shown generally in FIG. 2A for illustrative purposes. The use of one or more control and/or data buses for the interconnection between and communication among the various modules, circuits, and components would be known to a person skilled in the art in view of the invention described herein.

The memory 356 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 352 is connected to the memory 356 and executes software instructions that are capable of being stored in a RAM of the memory 356 (e.g., during execution), a ROM of the memory 356 (e.g., on a generally permanent basis), or another non-transitory computer readable medium such as another memory or a disc. Software included in the implementation of the power tool 10 can be stored in the memory 356 of the controller 304. The software includes, for example, firmware, one or more applications, program data, filters, rules, one or more program modules, and other executable instructions. The controller 304 is configured to retrieve from the memory 356 and execute, among other things, instructions related to the control processes and methods described herein. In other constructions, the controller 304 includes additional, fewer, or different components.

The battery pack interface 312 includes a combination of mechanical components (e.g., rails, grooves, latches, etc.) and electrical components (e.g., one or more terminals) configured to and operable for interfacing (e.g., mechanically, electrically, and communicatively connecting) the power tool 10 with a battery pack. For example, power provided by the battery pack to the nailer is provided through the battery pack interface 312 to the power input module 340. The power input module 340 includes combinations of active and passive components to regulate or control the power received from the battery pack prior to power being provided to the controller 304. The battery pack interface 312 also supplies power to the inverter 348 to be switched by the switching FETs to selectively provide power to the motor 308. The battery pack interface 312 also includes, for example, a communication line 384 to provide a communication line or link between the controller 304 and the battery pack.

The indicators 332 include, for example, one or more light-emitting diodes (“LEDs”). The indicators 332 can be configured to display conditions of, or information associated with, the power tool 10. For example, the indicators 332 are configured to indicate measured electrical characteristics of the power tool 10, the status of the device and/or the USB port 115-1, etc. The one or more user input modules 336 may be operably coupled to the controller 304 to, for example, select a mode of operation for the power tool 10, a mode of operation for the USB port 115-1, etc. In some embodiments, the one or more user input modules 336 may include a combination of digital and analog input or output devices required to achieve a desired level of operation for the power tool 10, such as one or more knobs, one or more dials, one or more switches, one or more buttons, etc. In some embodiments, the one or more user input modules 336 may receive signals wirelessly from a device external to the power tool 10 (e.g., a user's mobile phone).

The controller 304 may be configured to determine a state-of-charge (“SOC”) of the rechargeable battery pack 12. The controller 304 may also be configured to receive signals from a monitoring circuit (e.g., including sensors 324, etc.) that is configured to sense the SOC level, or voltage value, of battery cells of the rechargeable battery pack 12, and transmit the voltage readings to the controller 304. The voltage level of the battery cells may be determined by, for example, measuring the total open circuit voltage of the battery cells or by summing the voltage measurements of each battery cell. In some embodiments, the monitoring circuit is additionally configured to sense a discharge current of the battery cells (e.g., using a current sensor) of the rechargeable battery pack 12 and transmit the sensed current readings to the controller 304. The monitoring circuit is further configured to receive commands from the controller 304 during operation of the power tool 10. In some embodiments, the SOC, a sensed current, etc., of the rechargeable battery pack 12 is determined by the battery pack 12 and communicated to the power tool 10. The controller 304 may also be configured to determine whether a sink or source device is connected to the dual role port 115-1, and generate one or more control signals related to the connected device. The one or more control signals trigger control of charge and discharge paths related to the connected device and a power source of the power tool 10. In some embodiments, the power tool 10 may trigger the one or more control signals based on a determined SOC of the rechargeable battery pack 12. In some embodiments, the power tool 10 may trigger the one or more control signals based on a user selection received via the user input 336. Although the controller 304 is illustrated in FIG. 2A as one controller, the controller 304 could also include multiple controllers configured to work together to achieve a desired level of control for the power tool 10. As such, any control functions and processes described herein with respect to the controller 304 could also be performed by two or more controllers functioning in a distributed manner.

FIG. 2B illustrates a control system 400 for the rechargeable battery pack 12. The control system 400 includes a controller 401 and a plurality of battery cells 405. The controller 401 is electrically and/or communicatively connected to a variety of modules or components of the rechargeable battery pack 12. For example, the illustrated controller 401 is electrically connected to a battery pack interface device 412, one or more sensors or sensing circuits 424, a wireless communication controller 425, one or more indicators 432, a user input module 436, and the dual role port 115-2 (connected to a bidirectional DC conversion unit 437). The controller 401 includes combinations of hardware and software that are operable to, among other things, control and/or modify the operation of the USB port 115-2, control the operation of the rechargeable battery pack 12, monitor the operation of the rechargeable battery pack 12, activate the one or more indicators 432 (e.g., an LED), etc. The bidirectional DC conversion unit 437 will be described in more detail below.

The controller 401 includes a plurality of electrical and electronic components that provide power, operational control, and protection to the components and modules within the controller 401 and/or the rechargeable battery pack 12. For example, the controller 401 includes, among other things, a processing unit 440 (e.g., a microprocessor, a microcontroller, an electronic processor, an electronic controller, or another suitable programmable device), a memory 445, input units 450, and output units 455. The processing unit 440 includes, among other things, a control unit 460, an ALU 465, and a plurality of registers, and is implemented using a known computer architecture (e.g., a modified Harvard architecture, a von Neumann architecture, etc.). The processing unit 440, the memory 445, the input units 450, and the output units 455, as well as the various modules or circuits connected to the controller 401 are connected by one or more control and/or data buses (e.g., common bus 475). The control and/or data buses are shown generally in FIG. 2B for illustrative purposes. The use of one or more control and/or data buses for the interconnection between and communication among the various modules, circuits, and components would be known to a person skilled in the art in view of the invention described herein. Although the controller 401 is illustrated in FIG. 2B as one controller, the controller 401 could also include multiple controllers configured to work together to achieve a desired level of control for the rechargeable battery pack 12. As such, any control functions and processes described herein with respect to the controller 401 could also be performed by two or more controllers functioning in a distributed manner.

The memory 445 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 440 is connected to the memory 445 and executes software instructions that are capable of being stored in a RAM of the memory 445 (e.g., during execution), a ROM of the memory 445 (e.g., on a generally permanent basis), or another non-transitory computer readable medium such as another memory or a disc. Software included in the implementation of the rechargeable battery pack 12 can be stored in the memory 445 of the controller 401. The software includes, for example, firmware, one or more applications, program data, filters, rules, one or more program modules, and other executable instructions. The controller 401 is configured to retrieve from the memory 445 and execute, among other things, instructions related to the control processes and methods described herein. In other constructions, the controller 401 includes additional, fewer, or different components.

The battery pack interface device 412 includes a combination of mechanical components (e.g., rails, grooves, latches, etc.) and electrical components (e.g., one or more terminals) configured to and operable for interfacing (e.g., mechanically, electrically, and communicatively connecting) the battery pack 12 to a power tool or power tool device. For example, power provided by the rechargeable battery pack 12 to the power tool 10 is provided through the battery pack interface 412. The battery pack interface 412 also includes, for example, a communication line 484 for provided a communication line or link between the controller 401 and the power tool 10.

The indicators 432 include, for example, one or more light-emitting diodes (“LEDs”). The indicators 432 can be configured to display conditions of, or information associated with, the rechargeable battery pack 12. For example, the indicators 432 are configured to indicate measured electrical characteristics of the rechargeable battery pack 12, the status of the rechargeable battery pack 12 and/or the USB port 115-2, etc. The user input module 436 is operably coupled to the controller 401 to, for example, select a mode of operation (e.g., charge, discharge) for the rechargeable battery pack 12. In some embodiments, the user input module 436 includes a combination of digital and analog input or output devices required to achieve a desired level of operation for the rechargeable battery pack 12, such as one or more knobs, one or more dials, one or more switches, one or more buttons, etc.

During operation of the rechargeable battery pack 12, the controller 401 is configured to monitor voltage, current, temperature, and/or other signals received from the various components described above. For example, the controller 401 is configured to monitor voltage signals received from the battery cells 405 when the rechargeable battery pack 12 is charged by a power source of a device connected to the USB port 115-2. As another example, the controller 401 is configured to monitor voltage signals received from the battery cells 405 when the rechargeable battery pack 12 provides power to one or more peripheral devices connected to the battery pack interface 412. More generally, the controller 401 is configured to monitor and/or control power flow to and from the above-described components of the rechargeable battery pack 12 that are electrically and communicatively coupled to the controller 401. Additionally, the controller 401 is configured to provide information and/or control signals to another component of the battery pack (e.g., the battery pack interface 412, the USB port 115-2, the indicators 430, etc.).

The controller 401 may be configured to determine a state-of-charge (“SOC”) of the rechargeable battery pack 12. The controller 401 may also be configured to receive signals from a monitoring circuit (e.g., including sensors 424, etc.) that is configured to sense the SOC level or voltage value of the battery cells 405 of the rechargeable battery pack 12. The voltage level of the battery cells 405 may be determined by, for example, measuring the total open circuit voltage of the battery cells 405 or by summing the voltage measurements of each battery cell. In some embodiments, the monitoring circuit is additionally configured to sense a discharge current of the battery cells 405 (e.g., using a current sensor) of the rechargeable battery pack 12 and transmit the sensed current readings to the controller 401. The monitoring circuit is further configured to receive commands from the controller 401 during operation of the power tool 10. In some embodiments, a sensed current of the rechargeable battery pack 12 is determined by the rechargeable battery pack 12 and communicated to the power tool 10. The controller 401 may also be configured to determine whether a sink or source device is connected to the dual role port 115-2, and generate one or more control signals related to the connected device. The one or more control signals trigger control of charge and discharge paths related to the connected device and a power source of the rechargeable battery pack 12. In some embodiments, the rechargeable battery pack 12 may trigger the one or more control signals based on a determined SOC of the rechargeable battery pack 12. In some embodiments, the battery pack 12 may trigger the one or more control signals based on a user selection received via the user input 436.

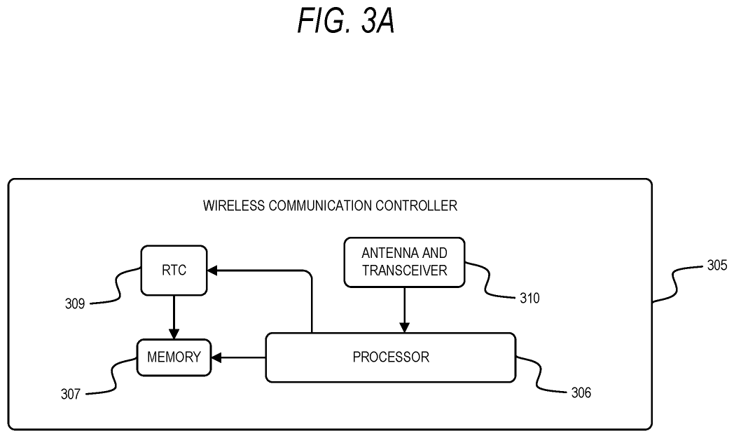

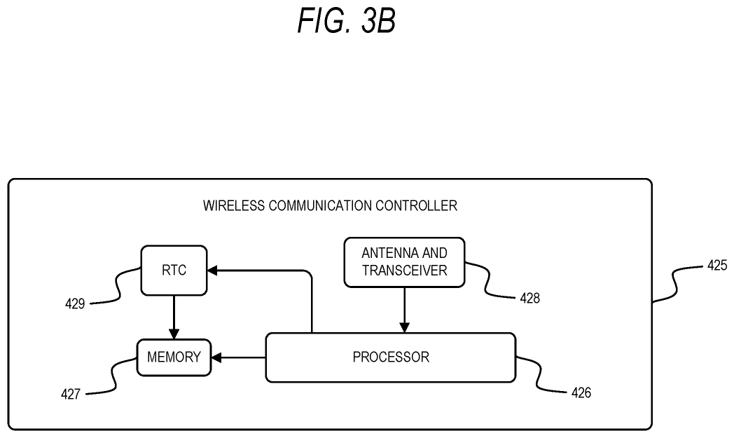

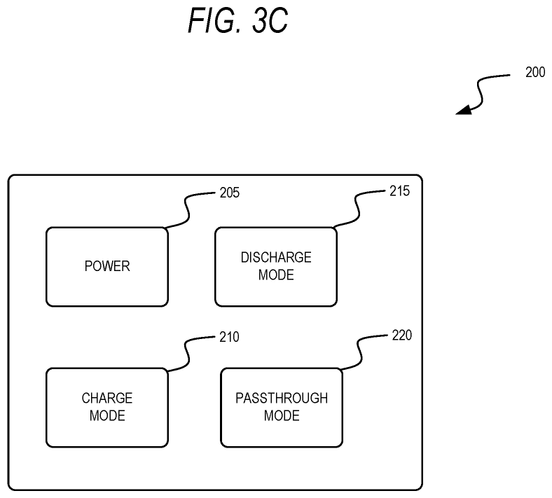

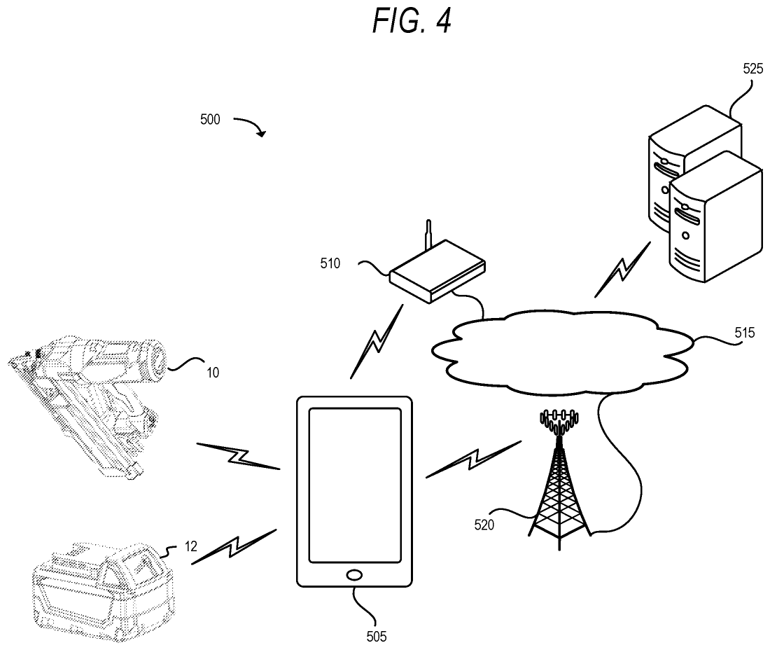

FIG. 3A provides an illustration of the wireless communication controller 305 that includes a processor 306, a memory 307, an antenna and transceiver 310, and a real-time clock (“RTC”) 309. The wireless communication controller 305 enables the power tool 10 to communicate with an external device 505 (see, e.g., FIG. 4). The radio antenna and transceiver 310 operate together to send and receive wireless messages to and from the external device 505 and the processor 306. The memory 307 can store instructions to be implemented by the processor 306 and/or may store data related to communications between the power tool 10 and the external device 505 or the like. The RTC 309 can increment and keep time independently of the other device components. The RTC 309 can receive power from the rechargeable battery pack 12 when the rechargeable battery pack 12 is connected to the power tool 10. The processor 306 for the wireless communication controller 305 controls wireless communications between the power tool 10 and the external device 505. For example, the processor 306 associated with the wireless communication controller 305 buffers incoming and/or outgoing data, communicates with the controller 304, and determines the communication protocol and/or settings to use in wireless communications. The communication via the wireless communication controller 305 can be encrypted to protect the data exchanged between the power tool 10 and the external device 505 or the rechargeable battery pack 12 from third parties.

FIG. 3B provides an illustration of the wireless communication controller 425 that includes a processor 426, a memory 427, an antenna and transceiver 428, and a real-time clock (“RTC”) 429. The wireless communication controller 425 enables the rechargeable battery pack 12 to communicate with the external device 505 or power tool 10. The radio antenna and transceiver 428 operate together to send and receive wireless messages to and from the external device 505 and the processor 426. The memory 427 can store instructions to be implemented by the processor 426 and/or may store data related to communications between the rechargeable battery pack 12 and the external device 505 or the like. The RTC 429 can increment and keep time independently of the other device components. The RTC 429 can receive power from the rechargeable battery pack 12. The processor 426 for the wireless communication controller 425 controls wireless communications between the rechargeable battery pack 12 and the external device 505. For example, the processor 426 associated with the wireless communication controller 425 buffers incoming and/or outgoing data, communicates with the controller 401, and determines the communication protocol and/or settings to use in wireless communications. The communication via the wireless communication controller 425 can be encrypted to protect the data exchanged between the rechargeable battery pack 12 and the external device 505 or the power tool 10 from third parties.

The wireless communication controller 425 and the wireless communication controller 305 may be referred to herein as “the wireless communication controller.” In some embodiments, the wireless communication controller is a Bluetooth® controller. The Bluetooth® controller communicates with the external device 505 employing the Bluetooth® protocol. Therefore, in the illustrated embodiment, the external device 505, the power tool 10, and/or the rechargeable battery pack 12 are within a communication range (i.e., in proximity) of each other while they exchange data. In other embodiments, the wireless communication controller communicates using other protocols (e.g., Wi-Fi, ZigBee, a proprietary protocol, etc.) over different types of wireless networks. For example, the wireless communication controller may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

The wireless communication controller 425 is configured to receive data from the controller 304 or the controller 401 and relay the information to the external device 505 via the antenna and transceiver 310 or the antenna and transceiver 428. In a similar manner, the wireless communication controller is configured to receive information (e.g., configuration and programming information) from the external device 505 via the antenna and transceiver 310 or the antenna and transceiver 428 and relay the information to the controller 304 or the controller 401.

FIG. 3C provides an illustration of user interface 200 for the power tool 10 or the rechargeable battery pack 12. In some embodiments, the user interface 200 is included in the external device 505. The user interface 200 includes a plurality of graphical user interface elements, such as, a power control input 205, a charge mode 210, a discharge mode 215, and a passthrough mode 220. The power control input 205 is configured to enable a user to activate and deactivate (e.g., turn ON and OFF) the USB port 115-1 or the USB port 115-2, referred to collectively or individually as the “USB port.” The charge mode 210 is configured to enable a user to control operation of the USB port according to a first set of operating parameters. For example, the charge mode 210 configures the USB port to operate as a source and provide power from a device connected to the USB port to the rechargeable battery pack 12. In some embodiments, the USB port also provides power from a device connected to the USB port to the power tool 10. The discharge mode 215 is configured to enable a user to control operation of the USB port according to a second set of operating parameters. For example, the discharge mode 215 configures the USB port to operate as a sink and provide power from the rechargeable battery pack 12 to a device connected to the USB port. The passthrough mode 220 is configured to enable a user to control operation of the USB port according to a third set of operating parameters. For example, the passthrough mode 220 configures the USB port to operate as a source and provide power from a device connected to the USB port to the power tool 10 and/or the rechargeable battery pack 12. In some implementations, when the rechargeable battery pack 12 is connected to the power tool 10, the USB port 115-1 provides power from a connected device to the power tool 10, which allows power from the connected device (e.g., an external source) to charge the rechargeable battery pack 12. In some implementations, when the rechargeable battery pack 12 is connected to the power tool 10, the USB port 115-2 provides power from a connected device to rechargeable battery pack 12. The rechargeable battery pack 12 provides power from the connected device to the power tool 10, which allows residual power from the connected device to charge the rechargeable battery pack 12.

FIG. 4 illustrates a communication system 500. The communication system 500 includes at least one power tool device (e.g., illustrated as the power tool 10), at least one battery pack (e.g., illustrated as the rechargeable battery pack 12), and the external device 505. The power tool 10, the rechargeable battery pack 12, and the external device 505 can communicate wirelessly while they are within a communication range of each other. The power tool 10 may communicate a status (e.g., state of charge of connected battery), operation statistics, sensor data, stored usage information, and the like associated with the power tool 10. The rechargeable battery pack 12 may communicate a status (e.g., state of charge), operation statistics, sensor data, stored usage information, and the like associated with rechargeable battery pack 12. Although the power tool 10 is illustrated, any other type of power tool can be provided with the same or similar communications capabilities.

More specifically, the power tool 10 or the rechargeable battery pack 12 can monitor, log, and/or communicate various operational parameters. The external device 505 can also transmit data to the power tool 10 or the rechargeable battery pack 12 for operational configuration, firmware updates, or to send commands. The external device 505 also allows a user to set operational parameters, safety parameters, select tool modes, and the like for the power tool 10 or the rechargeable battery pack 12.

The external device 505 is, for example, a smart phone (as illustrated), a laptop computer, a tablet computer, a personal digital assistant (“PDA”), or another electronic device capable of communicating wirelessly with the power tool 10 or the rechargeable battery pack 12 Also, the external device 505 is capable of providing the user interface 200 (see, e.g., FIG. 3C). The external device 505 provides the user interface 200 and allows a user to access and interact with the power tool 10 or the rechargeable battery pack 12. The external device 505 can receive user inputs to determine operational parameters, enable or disable features, and the like. The user interface 200 of the external device 505 provides an easy-to-use interface for the user to control and customize and/or modify operation of the rechargeable battery pack 12, the power tool 10, or a different type of power tool device.

In addition, as shown in FIG. 4, the external device 505 can also share the operational data obtained from the power tool 10 or the rechargeable battery pack 12 with a remote server 525 connected through a network 515. The remote server 525 may be used to store the operational data obtained from the external device 505, provide additional functionality and services to the user, or a combination thereof. In some embodiments, storing the information on the remote server 525 allows a user to access the information from a plurality of different locations. In some embodiments, the remote server 525 collects information from various users regarding their power tool devices and provide statistics or statistical measures to the user based on information obtained from the different power tools. The network 515 may include various networking elements (routers 510, hubs, switches, cellular towers 520, wired connections, wireless connections, etc.) for connecting to, for example, the Internet, a cellular data network, a local network, or a combination thereof, as previously described. In some embodiments, the power tool 10 and/or the rechargeable battery pack 12 are configured to communicate directly with the remote server 525 through an additional wireless interface or with the same wireless interface that the power tool 10 or the rechargeable battery pack 12 uses to communicate with the external device 505.

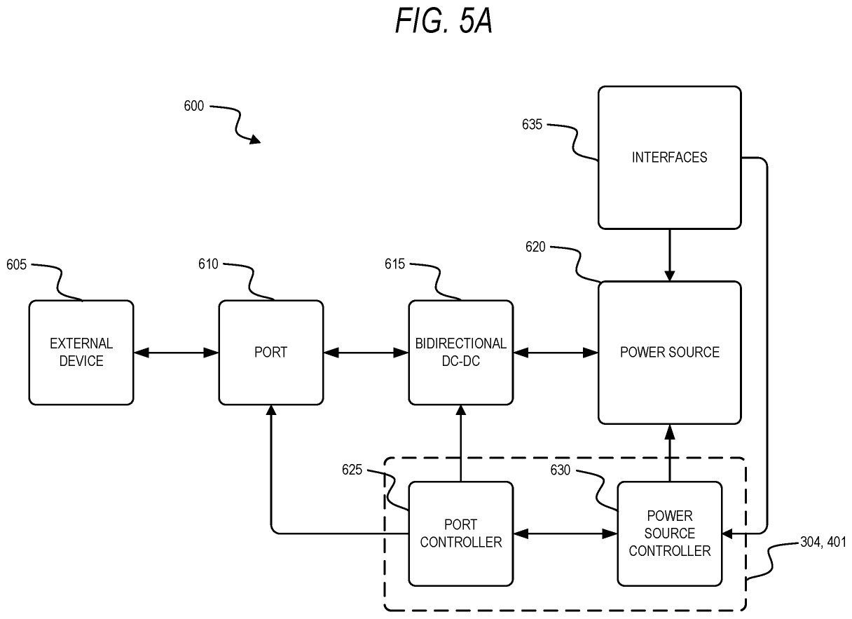

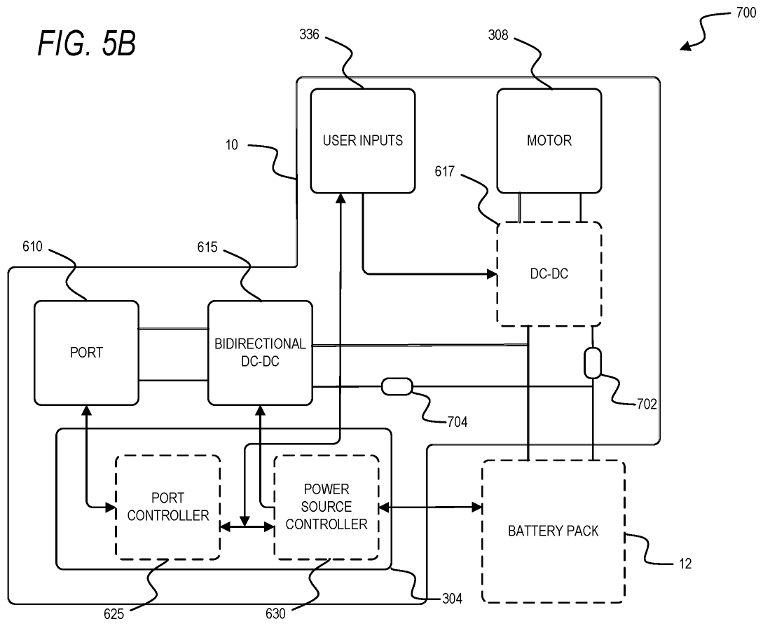

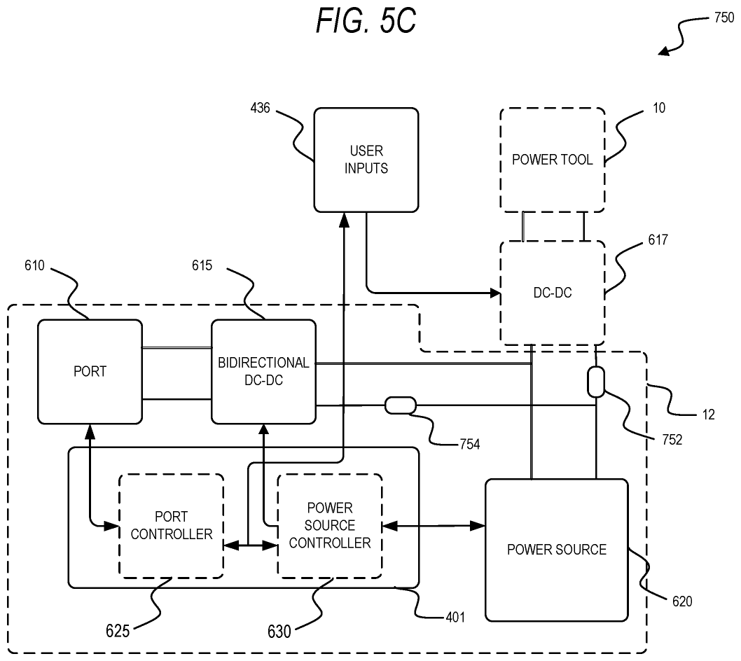

FIG. 5A provides an illustration of a bidirectional port system 600 according to some embodiments. The port system 600 could be implemented in either the power tool 10 or the rechargeable battery pack 12. As shown in FIG. 5A, the port system 600 includes an external device 605, a port 610, a bidirectional DC-DC device 615, a power source 620, a port controller 625, a power source controller 630, and interfaces 635. The external device 605 is, for example, a smart phone, a laptop computer, a tablet computer, a personal digital assistant (“PDA”), or another electronic device capable of providing (e.g., source device) and/or receiving (e.g., sink device) power when connected to the port 610, as described above. The port 610 is, for example, a USB-C power deliver (PD) port (e.g., a dual role port) that is capable of bidirectional power delivery, and is configured to operate as a sink or a source. The port 610 may alternate between sink and source states (e.g., roles). The bidirectional DC-DC device 615 is, for example, a converter (e.g., the bidirectional conversion unit 437, 337) that steps up or steps down DC voltage from either side of the converter when switching the port 610 between sink and source states. The bidirectional DC-DC device 615 is configured to transfer power between the port 610 and the power source 620. The bidirectional DC-DC device 615 may include combinations of active and passive components to regulate or control the power received from the power source 620 prior to power being provided to the port 610, and vice versa. The power source 620 is, for example a power source (e.g., the rechargeable battery pack 12), configured to provide or receive power from the port 610. The port controller 625 is electrically and/or communicatively connected to the port 610, the bidirectional DC-DC device 615, and the power source controller 630. The port controller 625 includes combinations of hardware and software and is configured to enable operation of the port 610, control the bidirectional DC-DC device 615 according to the state of the port 610 to protect the port 610, and communicate information related to the port 610 and the bidirectional DC-DC device 615 to the power source controller 630. The power source controller 630 is electrically and/or communicatively connected to the power source 620, the port controller 625, and the interfaces 635. The port controller 625 includes combinations of hardware and software and is configured to, among other things, control the operation of the power source 620, the operation of the port 610, and receive communications from the interfaces 635. In some embodiments, the power source controller 630 and the port controller 625 may be one controller (the controller 304, the controller 401) functioning in a centralized manner. In some embodiments, the bidirectional port system 600 includes additional, fewer, or different components.

FIG. 5B provides an illustration of a bidirectional port system 700 integrated within the power tool 10, according to some embodiments. As shown in FIG. 5B, the port system 700 includes the power tool 10. The power tool 10 includes the controller 304, the motor 308, the user inputs 336, the port 610, the bidirectional DC-DC device 615, and current sensors 702 and 704. The current sensor 702 is configured to sense current of a discharge path of the motor 308. The current sensor 704 is configured to sense current of a discharge/charge path of the port 610. In some embodiments, the port system 700 may also include the rechargeable battery pack 12. In some embodiments, the power tool 10 may also include a DC-DC conversion device 617. The DC-DC conversion device 617 is connected between the motor 308 and the rechargeable battery pack 12. The DC-DC conversion device 617 is, for example, a regulator (e.g., the power input module 340), that is configured to regulate or control a voltage required by other classes of power tools and the power tool 10 according to operating parameters associated with a user input. The DC-DC conversion device 617 may include combinations of active and passive components to regulate or control the power received from the battery pack 12 and/or an external device prior to power being provided to the motor 308.

In some embodiments, the controller 304 receives an indication from the user input 336 associated with the charge mode 210. The controller 304 receives a response to a communication (e.g., an OLiP or another wired communication, an I2C communication, a serial communication, a parallel communication, a wireless communication, a proprietary communication, etc.) sent to a user device (e.g., external power source) connected to the port 610 and determines that the user device is a source device. The controller 304 then configures the bidirectional DC-DC device 615 to regulate a voltage of the port 610 and transfer power provided by the user device to the power tool 10. Additionally, the controller 304 can receive another indication from the user input 336 associated with the passthrough mode 220. The controller 304 can provide power of the user device to the rechargeable battery pack 12 connected to the power tool 10. In some embodiments, the controller 304 receives an indication from the user input 336 associated with the discharge mode 215. The controller 304 receives a response to a communication (e.g., an OLiP or another wired communication, an I2C communication, a serial communication, a parallel communication, a wireless communication, a proprietary communication, etc.) sent to a user device (e.g., external power source) connected to the port 610 and determines that the user device is a sink device. The controller 304 configures the bidirectional DC-DC device 615 to regulate a voltage of the rechargeable battery pack 12 connected to the power tool 10 and transfer power provided by the rechargeable battery pack 12 to the user device connected to the port 610. In some instances, the rechargeable battery pack 12 provides power to the power tool 10 and the user device.

FIG. 5C provides an illustration of a bidirectional port system 750 integrated within the rechargeable battery pack 12, according to some embodiments. As shown in FIG. 5C, the port system 750 includes the controller 401, the user inputs 436, the port 610, the bidirectional DC-DC device 615, the power source 620, and current sensors 752 and 754. The current sensor 752 is configured to sense current of a discharge path of the battery pack 12. The current sensor 754 is configured to sense current of a discharge/charge path of the port 610. In some embodiments, the port system 750 may also include the power tool 10. In some embodiments, the power tool 10 may also be connected to the DC-DC conversion device 617. The DC-DC conversion device 617 connected between the power source 620 and the power tool 10. The DC-DC conversion device 617 is for example, a regulator (e.g., the power input module 340) configured to regulate or control a voltage required by other classes of power tools and the power tool 10 according to operating parameters associated with a user input.

In some embodiments, the controller 401 receives an indication from the user input 336 associated with the charge mode 210. The controller 401 receives a response to a communication (e.g., an OLiP or another wired communication, an I2C communication, a serial communication, a parallel communication, a wireless communication, a proprietary communication, etc.) sent to a user device (e.g., external power source) connected to the port 610 and determines that the user device is a source device. The controller 401 configures the bidirectional DC-DC device 615 to regulate a voltage of the port 610 and transfer power provided by the user device to charge the rechargeable battery pack 12. Additionally, the controller 401 can receive another indication from the user input 436 associated with the passthrough mode 220. The controller 401 can provide power of the user device to the power tool 10 connected to the rechargeable battery pack and power is used to charge the rechargeable battery pack 12. In some embodiments, the controller 401 receives an indication from the user input 436 associated with the discharge mode 215. The controller 401 receives a response to a communication (e.g., an OLiP or another wired communication, an I2C communication, a serial communication, a parallel communication, a wireless communication, a proprietary communication, etc.) sent to a user device (e.g., external power source) connected to the port 610 and determines that the user device is a sink device. The controller 401 configures the bidirectional DC-DC device 615 to regulate a voltage of the power source 620 and transfer power provided by the power source 620 to the user device connected to the port 610.

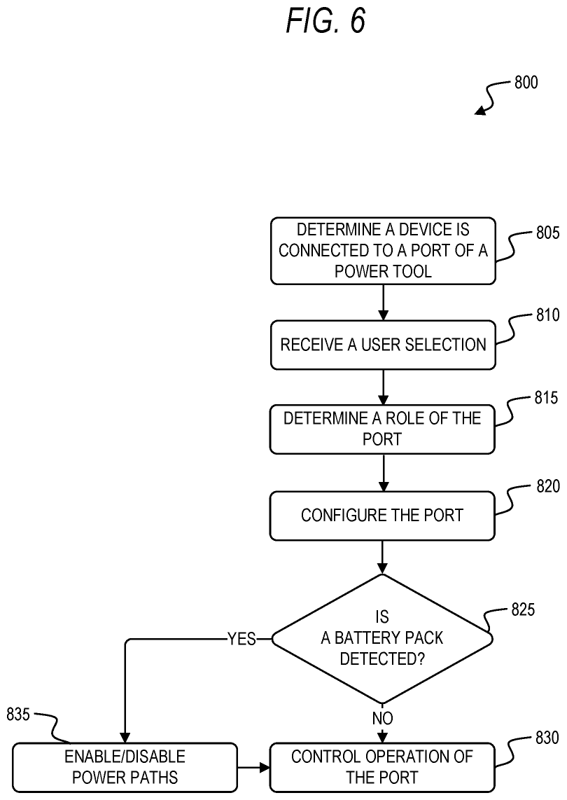

FIG. 6 illustrates a method 800 executed by the controller 304 of the power tool 10. The controller 304 receives, for example, a communication from the dual role port 115-1 of the power tool 10 that indicates that a device is connected (STEP 805). In some embodiments, the power tool 10 detects the device without receiving a communication. The controller 304 receives a communication from the user input 336 that includes operating parameters (e.g., charge function, discharge function, passthrough function) for the dual role port 115-1 of the power tool 10 (STEP 810). In some embodiments, the dual role port 115-1 is automatically configured by the controller 304. The controller 304 may send a communication to the device connected to the dual role port 115-1 and receive a response indicating the capabilities of the device. The controller 304 is configured to determine whether the device is a source or a sink (e.g., role) based on the response (STEP 815). The controller 304 enables the bidirectional DC conversion unit 337 to transfer power using the dual role port 115-1 to the device or from the device based on a role determined in STEP 815 (STEP 820). The controller 304 can use the communication line 384 to establish link or communication line between the controller 304 and the rechargeable battery pack 12 (STEP 825). If, at STEP 825, the controller 304 does not establish a link or communication line with the rechargeable battery pack 12, the controller 304 is configured to determine that the rechargeable battery pack 12 is not connected to the power tool 10 and continues to STEP 830. If, at STEP 825, the controller 304 establishes a link or communication line with the rechargeable battery pack 12, the controller 304 is configured to determine that the rechargeable battery pack 12 is connected to the power tool 10 and enable or disable additional charge or discharge paths associated with the rechargeable battery pack 12 (STEP 835). In some embodiments, STEP 835 is optional. The controller 304 uses, for example, a set of operating parameters associated with the communication from the user input 336 to control an operating mode of the dual role port 115-1 and the power tool 10 and/or the rechargeable battery pack 12 (STEP 830).

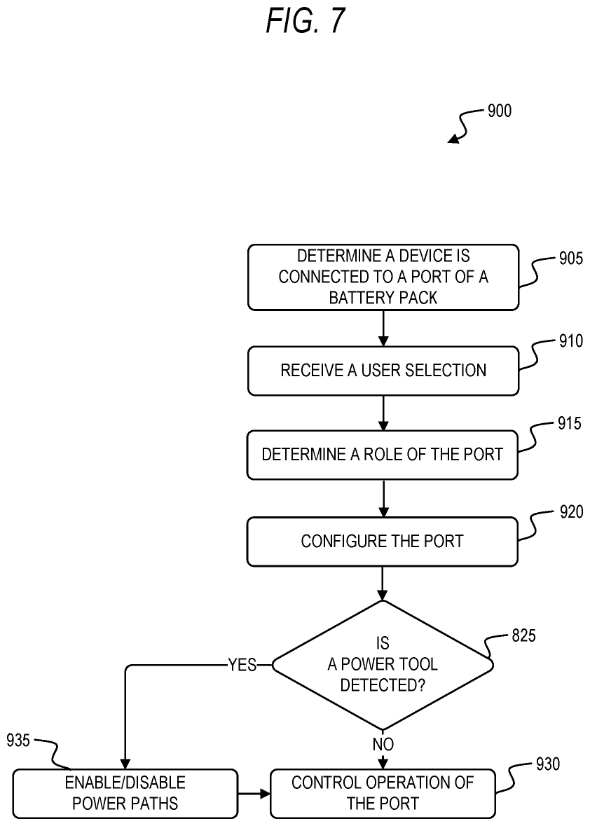

FIG. 7 illustrates a method 900 executed by the controller 401 of the rechargeable battery pack 12. The controller 401 receives, for example, a communication from the dual role port 115-2 of the rechargeable battery pack 12 that indicates that a device is connected (STEP 905). In some embodiments, the battery pack 12 detects the device without receiving a communication. The controller 401 receives a communication from the user input 436 that includes operating parameters (e.g., charge function, discharge function, passthrough function) for the dual role port 115-2 of the rechargeable battery pack 12 (STEP 910). In some embodiments, the dual role port 115-2 is automatically configured by the controller 401. The controller 401 may send a communication to the device connected to the dual role port 115-2 and receive a response indicating the capabilities of the device. The controller 401 is configured to determine whether the device is a source or a sink (e.g., role) based on the response (STEP 915). The controller 401 enables the bidirectional DC conversion unit 437 to transfer power using the dual role port 115-2 to the device or from the device based on a role determined in STEP 915 (STEP 920). The controller 401 can use the communication line 484 to establish link or communication line between the controller 401 and the power tool 10 (STEP 925). If, at STEP 925, the controller 401 does not establish a link or communication line with the power tool 10, the controller 401 is configured to determine that the power tool 10 is not connected to the rechargeable battery pack 12 and continues to STEP 930. If, at STEP 925, the controller 401 establishes a link or communication line with the power tool 10, the controller 401 is configured to determine that the power tool 10 is connected to the rechargeable battery pack 12 and enables or disables additional charge or discharge paths associated with the power tool 10 (STEP 935). In some embodiments, STEP 835 is optional. The controller 401 uses, for example, a set of operating parameters associated with the communication from the user input 436 to control an operating mode of the dual role port 115-2 and the rechargeable battery pack 12 and/or the power tool 10 (STEP 930).

Thus, embodiments described herein provide systems and methods for implementing a USB-C PD port in a power tool and/or a battery pack. Various features and advantages are set forth in the following claims.

What is claimed is:

1. A power tool comprising:
a dual role port configured to receive power from an external device or provide power to the external device;
a bidirectional converter device connected to the dual role port, the bidirectional converter device configured to transfer power from the dual role port to a power source of the power tool; and
an electronic controller configured to:
determine that the external device is connected to the dual role port,
determine a role of the dual role port, and
control operation of the dual role port.

2. The power tool of claim 1, further comprising:
a first sensing circuit connected to the dual role port and configured to sense current associated with the dual role port; and
a second sensing circuit connected to the power tool and configured to sense current associated with the power tool, and
wherein the power tool is operable to determine that the power source is connected to the power tool.

3. The power tool of claim 2, wherein the power tool is operable to use the dual role port to provide power from the external device to the power source of the power tool.

4. The power tool of claim 1, wherein the role of the dual role port is selected from a group consisting of: a sink and a source.

5. The power tool of claim 4, wherein the power tool is operable to modify operation of the dual role port responsive to receiving a user selection associated with an operating mode.

6. The power tool of claim 5, wherein the power tool is operable to use the bidirectional converter device to transfer power from the power source to the external device using the dual role port.

7. The power tool of claim 5, wherein the power tool is operable to use the bidirectional converter device to transfer power of the external device to the power source using the dual role port.

8. The power tool of claim 7, wherein the power tool includes a converter device connected to the power source, the converter device configured to regulate power received by the power tool.

9. A battery pack comprising:
a dual role port configured to receive power from an external device or provide power to the external device;
a bidirectional converter device connected to the dual role port, the bidirectional converter device configured to transfer power from the dual role port to a power tool or battery cells of the battery pack; and
an electronic controller configured to:
determine that the external device is connected to the dual role port,
determine a role of the dual role port, and
control operation of the dual role port.

10. The battery pack of claim 9, further comprising:
a first sensing circuit connected to the dual role port and configured to sense current associated with the dual role port; and
a second sensing circuit connected to the battery cells of the battery pack and configured to sense current associated with the battery cells of the battery pack, and
wherein the battery pack is operable to determine that the power tool is connected to the battery pack.

11. The battery pack of claim 10, wherein the battery pack is operable to use the dual role port to provide power from the external device to the connected power tool.

12. The battery pack of claim 9, wherein the role of the dual role port is selected from a group consisting of: a sink and a source.

13. The battery pack of claim 12, wherein the battery pack is operable to modify operation of the dual role port responsive to receiving a user selection associated with an operating mode.

14. The battery pack of claim 13, wherein the battery pack is operable to use the bidirectional converter device to transfer power to the external device from the battery cells of the battery pack using the dual role port.

15. The battery pack of claim 13, wherein the battery pack is operable to use the bidirectional converter device to transfer power to the battery cells of the battery pack from the external device using the dual role port.

16. The battery pack of claim 15, wherein the battery pack is operable to transfer power from the dual role port to the power tool.

17. A system comprising:
an external device;
a power source;
a dual role port electrically and communicatively connectable to the external device, the dual role port configured to receive power from the external device or provide power to the external device;
a bidirectional DC-DC converter device electrically connectable to the power source and the dual role port, the bidirectional DC-DC converter device is configured to transfer power to at least one of the power source or the dual role port; and
an electronic controller connected to the dual role port, the power source, and the bidirectional DC-DC converter device,
the electronic controller configured to:
determine that the external device is connected to the dual role port,
determine a role of the dual role port, and
control operation of the dual role port.

18. The system of claim 17, wherein the role of the dual role port is selected from a group consisting of: a sink and a source.

19. The system of claim 18, wherein the electronic controller is further configured to:
transmit a communication to the external device connected to the dual role port;
receive, from the external device, a response to the communication indicating capabilities of the external device; and
determine whether the role of the dual role port is the sink or the source based on the capabilities of the external device.

20. The system of claim 17, wherein the electronic controller is further configured to use the bidirectional DC-DC converter device to transfer power to the external device from the power source using the dual role port or transfer power to the power source from the external device using the dual role port.
